(19) United States
(12) Patent Application Publication
(10) Pub. No.: US 2012/0152892 A1
(43) Pub. Date: Jun. 21, 2012

(54) METHOD FOR MANUFACTURING OPTICAL ELEMENT

(75) Inventors: Akihiro Morikawa, Osaka (JP); Kiminori Mizuuchi, Ehime (JP)

(73) Assignee: PANASONIC CORPORATION, Kadoma-shi, Osaka (JP)

(21) Appl. No.: 13/393,180

(22) PCT Filed: Sep. 15, 2010
(86) PCT No.: PCT/JP2010/005615

§ 371 Date: Feb. 28, 2012

(30) Foreign Application Priority Data
Oct. 16, 2009 (JP) 2009-239040

(51) Int. Cl. B29D 11/00; B05D 5/06

(52) U.S. Cl. 216/24; 427/162

(57) ABSTRACT

Provided is a method for manufacturing an optical element, the method including: an electrode forming step of forming metal films on the plus z face and minus z face of a ferroelectric substrate to fabricate electrodes; a periodic electrode forming step of forming the metal film on the plus z face into a periodic electrode; a polarization reversal forming step of applying a voltage between the periodic electrode and the electrode on the minus z face to form polarization-reversed regions in the ferroelectric substrate; a surface treating step of removing the electrode, the periodic electrode, and surface layers on the plus z face and minus z face of the ferroelectric substrate; and an annealing step of applying predetermined heat to the ferroelectric substrate having the surface layers removed therefrom.

### TECHNICAL FIELD

The present invention relates to a method for manufacturing an optical element having a polarization-reversed structure which is formed by the application of an electric field. Specifically, the present invention relates to a method for forming an optical element having polarization-reversed regions which is used for wavelength conversion elements, deflector elements, optical switches, phase modulators, and so on constituting coherent sources used in the fields of processing, optical information processing, optical measurement control, and so on.

### BACKGROUND ART

A polarization reversal phenomenon that forcibly reverses the polarization of a ferroelectric is used to form periodic polarization-reversed regions (a polarization-reversed structure) in the ferroelectric. The polarization-reversed regions formed thus are used for optical frequency modulators using surface acoustic waves, wavelength conversion elements using the reversal of nonlinear polarization, optical deflectors using a reversed structure in prismatic or lens shape, and so on. Particularly, by using this technique, it is possible to fabricate a wavelength conversion element having remarkably high conversion efficiency when the fundamental wave of input is converted into wavelength-converted light. Further, the wavelength conversion element is used to perform wavelength conversion on light of semiconductor laser, fiber laser, solid-state laser, and so on, so that high-power laser light sources can be applied in the fields of processing, printing, optical information processing, optical measurement control, and so on.

Methods for forming a periodic polarization-reversed region include a method for forming a periodic polarization-reversed region using the reversal of spontaneous polarization of a ferroelectric due to an electric field. Specifically, the minus z face of a substrate cut out along the z-axis direction is irradiated with an electron beam, or the plus z face thereof is irradiated with positive ions. In either case, polarization-reversed regions with a depth of several hundreds of μm are formed by an electric field which is formed by irradiated charged particles. Further, another method has been known in which a periodic electrode is formed on the plus z face, a flat electrode is formed on the minus z face, and a direct current or pulsed electric field is applied to form deep polarization-reversed regions having a high aspect ratio.

Moreover, various supplemental methods have been proposed for improving the characteristics of wavelength conversion elements. For example, in order that a wide polarization-reversed structure having a short period is formed deeply and uniformly, a method has been known in which polarization-reversed regions are formed, heating is then performed on a ferroelectric substrate at 200° C. or higher, and the front and back surfaces of the substrate are electrically short-circuited (e.g., see Patent Literature 1). This method can prevent the polarization-reversed regions from being eliminated and increase transparency in the substrate to reduce optical loss. Moreover, a method has been known in which heat is applied to a substrate with a surface thereof entirely covered by a conductive substance in order to remove an undesired polarization-reversed structure remaining after the formation of polarization reversal (e.g., see Patent Literature 2). Alternatively, a method has been known in which high temperature annealing is performed to fabricate a low-loss optical waveguide in order to achieve uniform refractive-index distribution after the formation of polarization reversal (e.g., see Patent Literature 3). As described above, high temperature heating is essential in manufacturing a polarization-reversed structure used for practical wavelength conversion elements, and the like.

### CITATION LIST

### Patent Literatures

Patent Literature 1: Japanese Patent Application Laid-Open Publication No. 2004-246332

Patent Literature 2: Japanese Patent Application Laid-Open Publication No. 2004-020876

Patent Literature 3: Japanese Patent Application Laid-Open Publication No. 8-220578

### SUMMARY OF INVENTION

### Technical Problem

However, for example, in wavelength conversion elements manufactured by the above-described methods including heating processes according to the related art, the heating processes cause small strains in the wavelength conversion elements. These strains increase the input power of the fundamental wave as well as the amounts of the fundamental wave and the wavelength-converted light thereof absorbed into the wavelength conversion elements, thereby reducing the output power of the wavelength-converted light.

Thus, even if the fundamental wave power is increased to obtain high-power wavelength-converted light exceeding 1 W, the conversion efficiency of the wavelength conversion element is reduced. Hence, it is difficult to obtain high-power wavelength-converted light.

### Solution to Problem

The present invention has been devised to solve the problem. An object of the present invention is to provide a method for manufacturing an optical element whose conversion efficiency is not lowered, even when the high-output fundamental wave is inputted to the optical element having a polarization-reversed structure subjected to heating.

In order to solve the problem, a method for manufacturing an optical element includes: an electrode forming step of forming metal films on the plus z face and minus z face of a ferroelectric substrate to fabricate electrodes; a periodic electrode forming step of forming the metal film formed on the plus z face into a periodic electrode; a polarization reversal forming step of applying a voltage between the periodic electrode and the electrode on the minus z face to form polarization-reversed regions in the ferroelectric substrate; a surface treating step of removing the electrode, the periodic electrode, and surface layers on the plus z face and minus z face of the ferroelectric substrate; and an annealing step of applying predetermined heat to the ferroelectric substrate having the surface layers removed therefrom.

### Advantageous Effects of Invention

The method for manufacturing an optical element of the present invention suppresses an increase in spontaneous polarization which causes strains in an optical element having a polarization-reversed structure manufactured by annealing. Thus, the strains are reduced in the optical element, and the fundamental wave and the wavelength-converted light thereof absorbed into the optical element are suppressed even when the input power of the fundamental wave is increased. Hence, it is possible to obtain an optical element whose conversion efficiency is not lowered.

### BRIEF DESCRIPTION OF DRAWINGS

FIG. 1 illustrates a method for manufacturing an optical element according to the present invention.

FIG. 2 shows a comparison in the optical output characteristics of optical elements between the related art and a first embodiment.

FIG. 3 shows changes in spontaneous polarization depending on the presence or absence of electrodes.

FIG. 4 shows changes in optical output characteristics depending on depths of polishing.

FIG. 5 is a cross-sectional view of an optical element before and after a surface treating step according to the present invention.

FIG. 6 shows the surface resistivity dependence of the optical output characteristics.

FIG. 7 shows the high temperature annealing temperature dependence of the optical output characteristics.

FIG. 8 shows the optical output characteristics of an optical element according to a second embodiment.

FIG. 9 is a cross-sectional view of an optical element with anisotropy in a z-axis direction before and after a surface treating step.

FIG. 10 shows the occurrence of pyroelectric charges of the optical element having steps according to the present invention.

### DESCRIPTION OF EMBODIMENTS

Before describing embodiments of the present invention, first, the polarization reversals of ferroelectrics will be described. The ferroelectric has uneven charge distribution due to spontaneous polarization in the crystal thereof. An electric field can be applied to change the direction of such spontaneous polarization in the ferroelectric.

The direction of the spontaneous polarization varies depending on the type of crystal (material). The crystals of substrates of LiTaO₃, LiNbO₃, and LiTa (1−x) NbxO₃ (0≦x≦1), which is the mixed crystal of LiTaO₃ and LiNbO₃, have spontaneous polarization only in the z-axis direction. Thus, these crystals have only two types of polarization in a plus direction along the z-axis direction or a minus direction opposite to the plus direction. An electric field is applied to turn the polarization of the crystals 180 degrees in a direction opposite to the initial direction. This phenomenon is called polarization reversal. The electric field required for causing the polarization reversal is referred to as a polarization reversal threshold electric field. The crystals of LiNbO₃, LiTaO₃, and the like require an electric field of about 20 kV/mm at room temperature, and MgO:LiNbO₃ requires an electric field of about 5 kV/mm.

The following will specifically describe embodiments of a method for manufacturing an optical element according to the present invention with reference to the accompanying drawings.

### First Embodiment

The present embodiment will describe a method for manufacturing a wavelength conversion element as an optical element having a periodic polarization-reversed structure in a ferroelectric substrate.

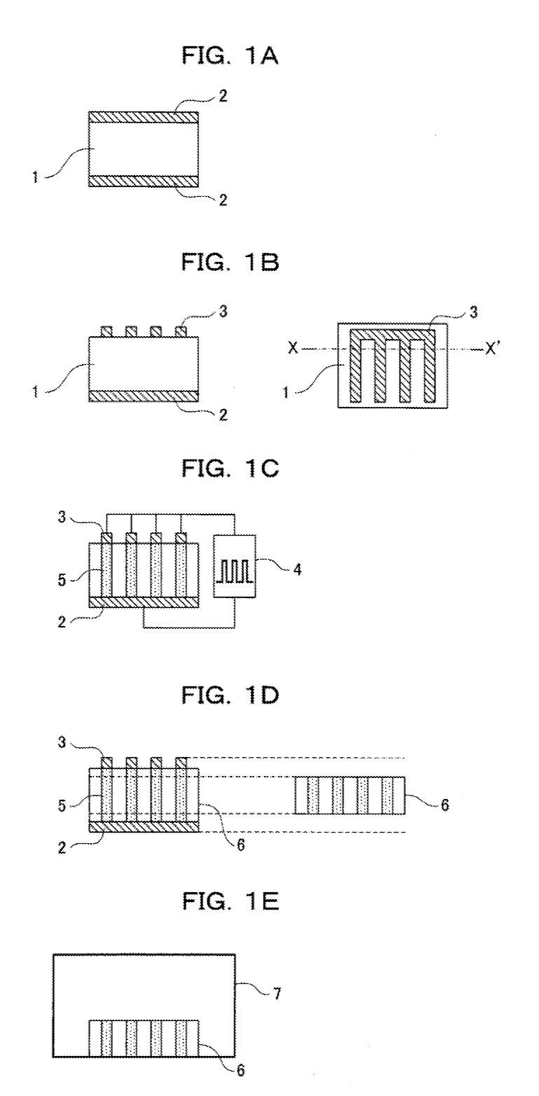

FIG. 1 illustrates a method for manufacturing an optical element according to the present invention using the fabrication of the wavelength conversion element as an example. The method for manufacturing an optical element according to the present invention includes an electrode forming step, a periodic electrode forming step, a polarization reversal forming step, a surface treating step, and an annealing step.

FIG. 1(a) shows the electrode forming step. A ferroelectric substrate 1 in the drawing is, in the present embodiment, a Z-cut MgO:LiNbO₃ substrate with a thickness of 1 mm. Electrodes 2 are formed on the plus z face and minus z face of the ferroelectric substrate 1 of the MgO:LiNbO₃ substrate. The electrodes 2 are made of metal films for polarization reversal formation. In the present embodiment, the electrodes 2 having a thickness of 100 nm are deposited by sputtering tantalum films.

FIG. 1(b) shows the periodic electrode forming step. The right drawing in FIG. 1(b) shows the plus z face as viewed from above. The left drawing is a cross-sectional view taken along the line X-X′ of the right drawing. The electrode 2 on the plus z face is fabricated into a comb-like periodic electrode 3 such that the plus z face has a periodic polarization-reversed structure. In the present embodiment, photolithography and dry etching are used to fabricate the periodic electrode 3. Further, the electrode period of the periodic electrode 3 is set to 7 μm to wavelength-convert near-infrared light (with a wavelength of 1064 nm) to green light (with a wavelength of 532 nm). The electrode period (actually, the period of polarization reversal to be fabricated) is determined by the refractive indices and phase matching wavelengths of near-infrared light and green light on the MgO:LiNbO₃ substrate. The polarization reversal period is accurately controlled to form polarization reversal, so that phase mismatching in the crystals of near-infrared light and green light can be compensated for to perform wavelength conversion with high efficiency.

FIG. 1(c) shows the polarization reversal forming step. A pulsed electric field equal to or larger than the polarization reversal threshold electric field is applied between the electrodes on the plus z face and the minus z face by a pulsed voltage application system 4 to form polarization reversal 5. At this point, when the temperature of the substrate is increased during the application of the electric field, the polarization reversal threshold electric field can be reduced to 5 kV/mm or less. For this reason, in the present embodiment, the ferroelectric substrate 1 is put in an insulating liquid, the temperature of the insulating liquid is set to 100° C., and the electric field is applied. The substrate is heated, so that the polarization reversal threshold electric field is reduced to 5 kV/mm or less. In this case, however, margins are allowed to set the pulsed electric field at 6 kV/mm and the pulse width at 1 msec. The pulsed electric field is applied, so that the reversal 5 is formed from the plus z face toward the minus z face of the substrate.

FIG. 1(d) shows the surface treating step. The left drawing in FIG. 1(d) is a cross-sectional view of a wavelength conversion element 6 before the surface treating step, and the right drawing is a cross-sectional view of the wavelength conversion element 6 after the surface treating step. In the surface treating step, the surfaces of the electrode 2, the periodic electrode 3, and the wavelength conversion element 6 are removed. In the present embodiment, the plus z face and minus z face of the wavelength conversion element 6 are polished with mechanical polishing of diamond coating grains, to remove a layer reaching a depth of about 100 nm from the surface of the substrate, together with the electrode 2 and the periodic electrode 3. The surface treating step is not performed in the related art. The surface treating step is performed before the high temperature annealing step, so that the conversion efficiency of the wavelength conversion element can be improved, which will be specifically described later.

In the present embodiment, the electrodes and the surface of the substrate are removed by polishing, but the process for removing is not limited to polishing. The same effect can be produced even by performing drying etching or wet etching to remove the electrodes and the surface of the substrate. Any dry etching may be used as long as both of the electrodes and the substrate can be etched. In wet etching, any acid or alkali solution may be used as long as the electrodes and the substrate can be etched.

FIG. 1(e) shows the annealing step. In the annealing step of the present embodiment, an oven 7 (manufactured by Kusumoto Chemicals, Ltd.) capable of heating at high temperature is used to anneal the wavelength conversion element 6 in an environment of 400° C. for one hour.

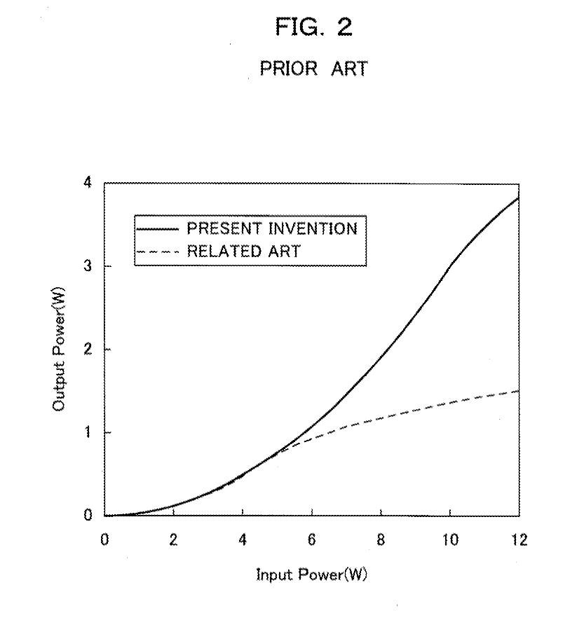

FIG. 2 shows a comparison in the optical output characteristics of an optical element between the related art and the first embodiment, and the relationship of the input power of infrared light and the output power of wavelength-converted light when the infrared light is inputted as the fundamental wave to the wavelength conversion element. The ordinate indicates the wavelength-converted light output power, and the abscissa indicates the fundamental wave input power. The dotted line indicates the characteristics of a wavelength conversion element fabricated by the manufacturing method of the related art, and the solid line indicates the characteristics of a wavelength conversion element fabricated by the manufacturing method of the present invention. As shown in FIG. 2, in the manufacturing method of the related art, when the fundamental wave input exceeds 5 W, the increase rate of wavelength-converted light decreases, whereas, in the manufacturing method of the present invention, until the fundamental wave input reaches 10 W, the output of wavelength-converted light increases with the square of the input power. That is, when the wavelength conversion element is fabricated by the manufacturing method of the preset invention, a reduction in conversion efficiency is suppressed. This is an effect produced by performing the surface treating step before the annealing step to remove the surface layers of the plus z face and minus z face of the wavelength conversion element. The following will describe the effect produced by removing the surface layers.

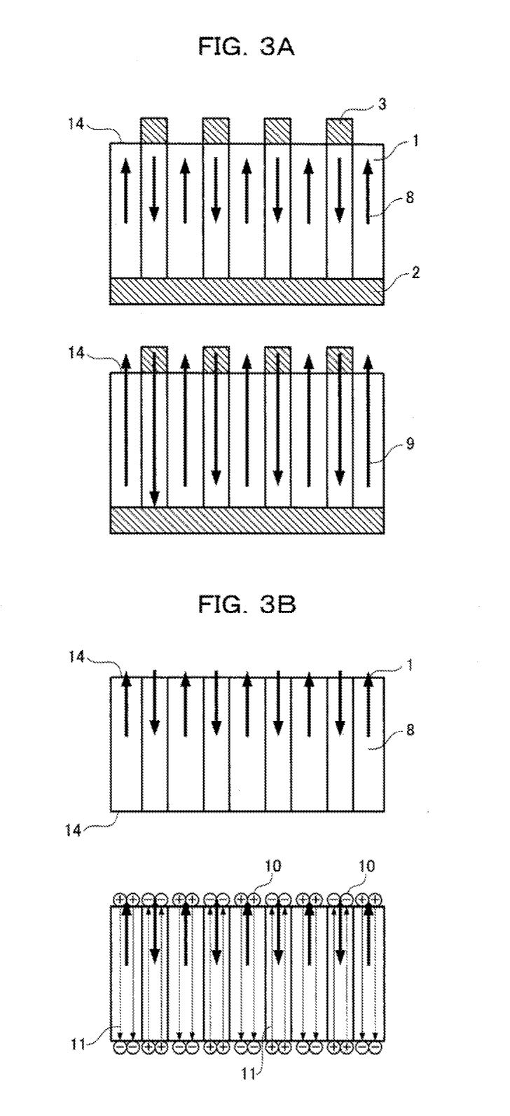

FIG. 3 shows changes in spontaneous polarization depending on the presence or absence of electrodes. FIG. 3(a) shows changes in spontaneous polarization before and after the annealing step in the wavelength conversion element fabricated by the method of the related art. The upper drawing in FIG. 3(a) shows spontaneous polarization before the annealing step, and the lower drawing shows spontaneous polarization during the annealing step. The directions of arrows in FIG. 3(a) indicate the directions of spontaneous polarization and the lengths of the arrows indicate the scales of spontaneous polarization. The electrode 2 and the periodic electrode 3 are used to form polarization reversal. The temperature of the ferroelectric substrate 1 is increased by the high temperature annealing step, so that spontaneous polarization 8 increases to annealing spontaneous polarization 9. At this point, when the ferroelectric substrate 1 is pure, pyroelectric charges are generated and accumulated on the surface of the ferroelectric substrate so as to reverse the annealing spontaneous polarization 9. This phenomenon is generally called a pyroelectric effect which is produced to have ferroelectric crystals maintain electroneutrality.

However, as shown in FIG. 3(a), pyroelectric charges generated by the pyroelectric effect freely moves along the electrode 2 and the periodic electrode 3 on a surface 14 of the ferroelectric substrate 1. As a result, since the pyroelectric charges are not accumulated on the surface 14 of the ferroelectric substrate 1, an electric field is not generated for reversing the annealing spontaneous polarization 9. Thus, the annealing spontaneous polarization 9 continuously increasing during the annealing step is adjacent to spontaneous polarization opposite thereto, so that strains (crystal strains) are caused in the crystal structure at the polarization-reversed region interface of different polarity. In elements having a large number of periodic polarization-reversed structures as in the wavelength conversion element, interfaces in large numbers are adjacent to each other, thereby increasing crystal strains. Laser light is inputted to such a wavelength conversion element to increase the input power, so that crystal strains increase the optical absorption of the wavelength conversion element and reduce the conversion efficiency of the wavelength conversion element.

FIG. 3(b) shows changes in spontaneous polarization during the high temperature annealing step in the wavelength conversion element fabricated by the manufacturing method of the present invention. The upper drawing in FIG. 3(b) shows spontaneous polarization before the high temperature annealing step, and the lower drawing shows spontaneous polarization during the high temperature annealing step. The electrode 2, the periodic electrode 3, and the surface of the substrate are removed in the wavelength conversion element of the present invention before the annealing step. Since the electrode 2 and the periodic electrode 3 are not present on the surface 14 of the ferroelectric substrate 1 of the MgO:LiNbO₃ substrate, pyroelectric charges 10 generated by the pyroelectric effect are accumulated on the surface 14 of the ferroelectric substrate 1 (see the lower drawing in FIG. 3(b)). Electric fields 11 generated by the pyroelectric charges 10 reverse the spontaneous polarization 8, so that the increase of the spontaneous polarization 8 is suppressed. Thus, the occurrence of strains in the crystals can be suppressed. As a result, even when the input power is increased, an increase in optical absorption can be suppressed unlike in the wavelength conversion element fabricated by the manufacturing method of the related art, and a reduction in the conversion efficiency of the wavelength conversion element can be suppressed.

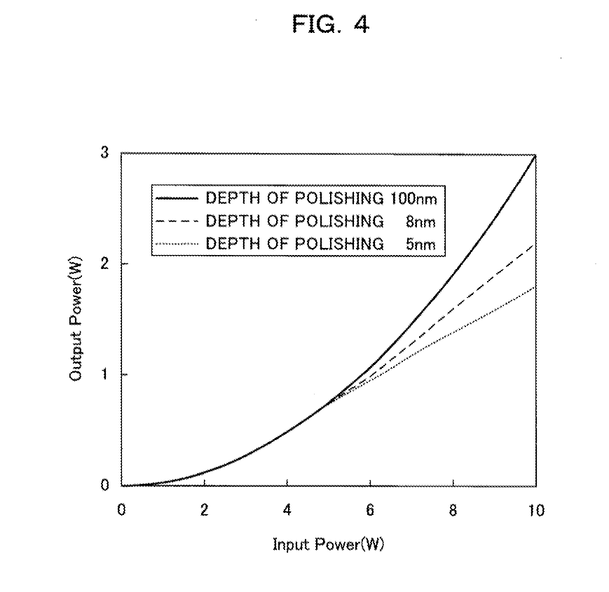

The depth of polishing from the substrate surface (crystal substrate surface excluding electrodes) is also important. Considerable effects can be obtained only by removing the surface electrodes but more remarkable effects can be obtained by increasing the depth of polishing to larger than 10 nm. FIG. 4 shows changes in optical output characteristics depending on the depths of polishing, and the relationship between the fundamental wave input power and the wavelength-converted light output power when the depth of polishing is changed. The depths in the graph of FIG. 4 are 100 nm (solid line), 8 nm (broken line), and 5 nm (dotted line). As the depth of polishing is reduced, the conversion efficiency is lowered. This phenomenon becomes apparent when the depth of polishing is 10 nm or less.

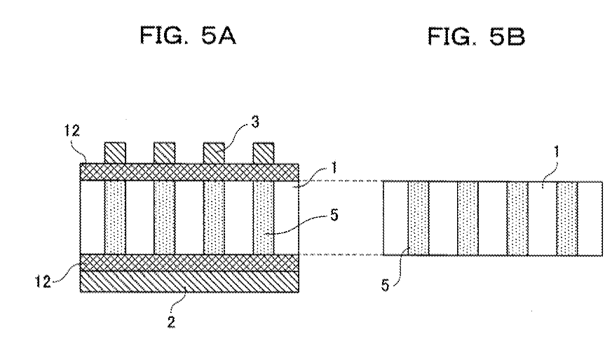

The following will describe the mechanism of an optical absorption-reducing effect depending on the depths of polishing. FIG. 5 is a cross-sectional view of the optical element according to the present invention before and after the surface treating step, and a cross-sectional view of the wavelength conversion element before and after the surface treating step with polishing. As shown in FIG. 5(a), altered layers 12 are generated on the surface layers of the ferroelectric substrate 1 before the surface treating step by mirror polishing or electrode deposition during the fabrication of a wafer on the ferroelectric substrate 1. Since the altered layers 12 contain a lot of conductive impurities, the above-described pyroelectric charges generated by the pyroelectric effect move a short distance through the altered layers. In addition to the massive movement of charges made simply by reducing the surface resistance as illustrated by FIG. 3, the movement of pyroelectric charges made by the altered layers 12 causes substrate strains at the interface where spontaneous polarization is reversely-oriented without suppressing the stretching and shrinkage of spontaneous polarization during the annealing step. The movement of charges due to the altered layers 12 is generally called DC drift, which has an effect on an increase in the optical absorption of a polarization-reversed portion in a wavelength conversion element having a short polarization reversal period of several microns. Thus, as shown in FIG. 5(b), the electrode 2, the periodic electrode 3, and the altered layers 12 formed on the substrate surface are completely removed, so that the movement of pyroelectric charges made by the high temperature annealing step can be suppressed. The experiments of the inventors showed that the altered layers 12 could be completely removed by polishing the substrate from the surface to a depth of over 10 nm, thereby preventing a reduction in conversion efficiency.

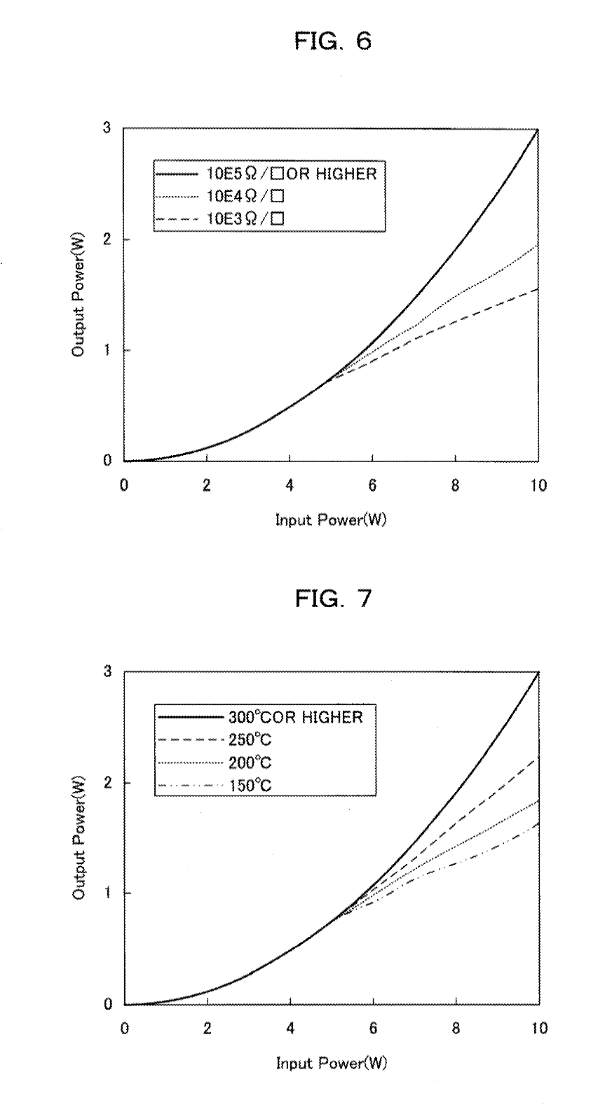

The adjustment of the surface resistivity when completing the surface treating step is also important. This is because the reduction of the surface resistivity accelerates the movement of pyroelectric charges made by the high temperature annealing step. In this case, the surface resistivity indicates the resistance per unit area of the plus z face and minus z face of the ferroelectric substrate, and the unit of the resistance is represented by Ω/□. In order that the movement of ferroelectric charges is suppressed to suppress substrate strains, the annealing step has to be performed with the surface resistivity set at 10⁵ Ω/□ or higher. A SiO₂ film is formed on the surface of the ferroelectric substrate and the film formation conditions are changed to adjust the contents of Si and O₂, so that the surface resistivity can be adjusted. As shown in FIG. 6 which will be described below, wavelength conversion elements having surface resistivity of 10³ Ω/□, 10⁴ Ω/□, and 10⁵ Ω/□ or higher are fabricated, and the output characteristics of the wavelength conversion elements are compared.

FIG. 6 shows the surface resistivity dependence of the optical output characteristics, and the relationship between the fundamental wave input power and the wavelength-converted light output power of the wavelength conversion elements having different surface resistivity. The wavelength conversion elements each have a plus z face and a minus z face which are polished from the surface of the substrate to a depth of 100 nm with mechanical polishing of diamond coating grains. As is apparent from the drawing, the conversion efficiency tends to be lowered with a reduction in the surface resistivity. Specifically, when the surface resistivity is 10³ Ω/□ or 10⁴ Ω/□, the optical absorption increases and the conversion efficiency decreases. However, when the surface resistivity is 10⁵ Ω/□ or higher, the conversion efficiency is not lowered.

Desirably, the conductive properties of the substrate surface are taken into consideration and contact with low-resistance materials is avoided. This is because the pyroelectric charges generated by the high temperature annealing step move through the low-resistance materials.

Thus, desirably, the annealing step is performed on the substrate which is provided on an insulator. This makes it possible to suppress an increase in spontaneous polarization according to the movement of pyroelectric charges through materials contacted by the substrate, thereby suppressing a reduction in the conversion efficiency of the wavelength conversion element.

The heating temperature of the annealing step is also important. The annealing step has to be performed at 300° C. or higher to reduce the optical absorption and prevent the reduction of the conversion efficiency. The Mg-doped LiNbO₃ substrate of the present embodiment is subjected to the annealing step.

FIG. 7 shows the high temperature annealing temperature dependence of the optical output characteristics, and the relationship between the fundamental wave input power and the wavelength-converted light output power of wavelength conversion elements fabricated by the annealing step at different heating temperatures. The wavelength conversion elements are made of a MgO:LiNbO₃ substrate having a plus z face and a minus face which are polished from the substrate surface to a depth of 10 nm with mechanical polishing of diamond coating grains. As is apparent from the drawing, the conversion efficiency tends to be lowered with a reduction in heating temperature. Specifically, as the annealing temperature was gradually reduced to 250° C., 200° C., or 150° C., the conversion efficiency was lowered. Meanwhile, when the annealing temperature was 300° C. or higher, the conversion efficiency was not lowered. The annealing temperature corresponding to the threshold value of reduction of the conversion efficiency varies depending on the material of the crystal substrate. The threshold temperature is 100° C. or higher in Mg-doped LiTaO₃ substrates and LiTaO₃-based substrates, but is 300° C. or higher in LiNbO₃-based substrates. This is thought to depend on a difference in Curie temperature between crystals.

As described above, desirably, the annealing step is performed at an annealing temperature predetermined by the material of the substrate.

The wavelength conversion element used in the present embodiment has a polarization-reversed structure in which the period is 7 μm and the polarization reversal width is 3.5 μm in the periodic direction. It was confirmed that fabricated polarization-reversed regions were not eliminated although they were subjected to annealing at 400° C. Thereafter, even when heat cycling was performed on the polarization-reversed regions at −20° C. to 100° C., the polarization-reversed structure was not eliminated and the conversion efficiency was not lowered. However, with the polarization reversal width set to 1 μm in the periodic direction, the polarization-reversed regions were partially eliminated even when the annealing step was performed at 100° C. As a result of performing experiments by gradually increasing the polarization reversal width, with the polarization reversal width of 2 μm or larger in the periodic direction, the polarization-reversed structure was not eliminated even when the annealing step was performed at 400° C. Even when the subsequent heat cycling was performed on the polarization-reversed structure at −20° C. to 100° C., the polarization-reversed structure was not eliminated and the conversion efficiency was not lowered. Thus, the present invention is remarkably useful as a method for manufacturing an optical element which effectively stabilizes a polarization-reversed structure with a polarization reversal width of 2 μm or larger and removes crystal strains at the interface of the polarization-reversed structure.

### Second Embodiment

In the first embodiment, the surface treating step is performed by means of mechanical polishing. However, the present embodiment is different from the first embodiment in that anisotropic wet etching is performed in the z-axis direction of a substrate as the surface treating step. The method makes it possible to prevent a reduction in conversion efficiency at the time of high output.

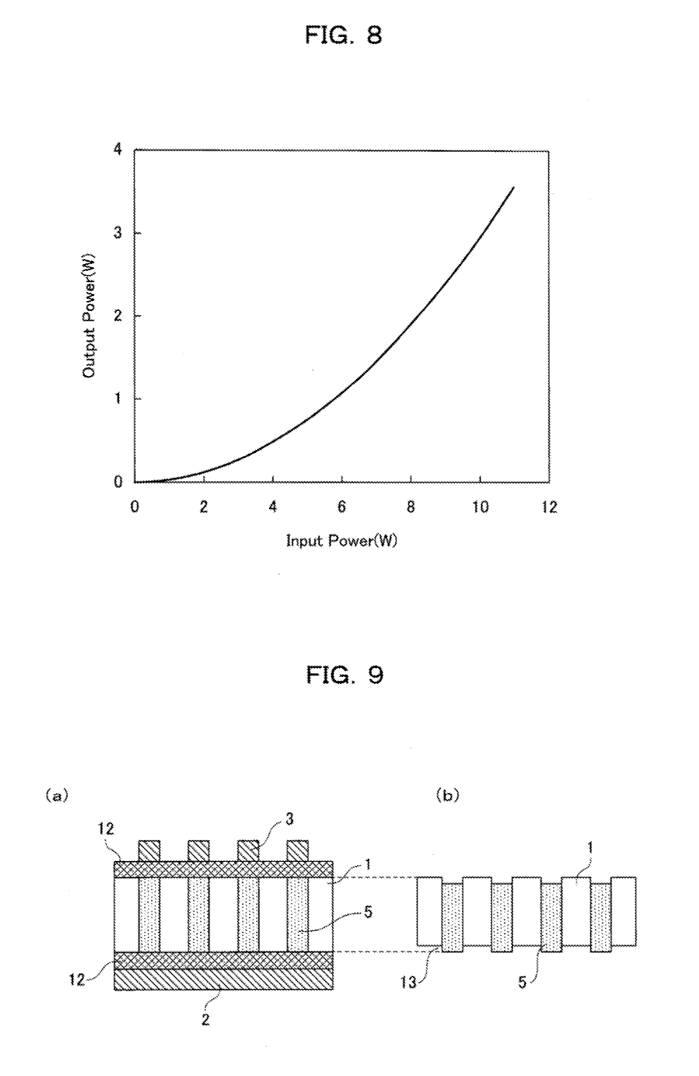

FIG. 8 shows the optical output characteristics of an optical element according to a second embodiment, and the relationship of input power and wavelength-converted light output power in a wavelength conversion element having a thickness of about 100 nm removed from the substrate surface using a fluoronitric acid solution. As is apparent from the drawing, even when the fundamental wave input exceeds 10 W, the output of wavelength-converted light in proportion to the square of the input power can be obtained. That is, the conversion efficiency is not lowered even in the case of higher input power than in the first embodiment.

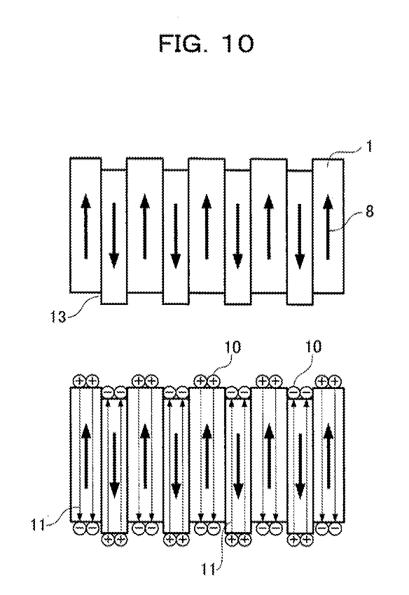

FIG. 9 is a cross-sectional view of an optical element before and after the surface treating step with anisotropy in the z-axis direction, and a cross-sectional view of the optical element subjected to the surface treating step using a wet etching solution with anisotropy in the z-axis direction. In this case, the anisotropy in the z-axis direction indicates different etching rates depending on the orientations of faces (plus z face, minus z face) perpendicular to the directions of spontaneous polarization. Specifically, the directions of spontaneous polarization are alternately reversed, so that layers having different etching rates are alternately present on the plus z face and minus z face of a ferroelectric substrate 1. In this case, the plus z face and the minus z face are periodically repeated in the optical element having periodic polarization reversal, the faces having different etching rates therein, so that periodic steps 13 are formed on the surface of the substrate. The etching rate of the fluoronitric acid solution in the minus z face is faster than that in the plus z face of a MgO:LiNbO₃ substrate (because of the anisotropy). Thus, wet etching is performed, so that the periodic steps 13 are formed in the polarization-reversed optical element. The sizes of the steps 13 increase with the etching time. In the present embodiment, etching was performed for 20 minutes using a fluoronitric acid solution, so that steps of several tens of nm could be obtained.

FIG. 10 shows the occurrence of pyroelectric charges on the optical element having steps according to the present invention, and spontaneous polarization during the high temperature annealing step in the wavelength conversion element subjected to the surface treating step according to the present embodiment. The upper drawing in FIG. 10 shows spontaneous polarization before the high temperature annealing step, and the lower drawing shows spontaneous polarization during the high temperature annealing step. The steps 13 formed by anisotropic wet etching prevent the movement of pyroelectric charges 10 generated during the high temperature annealing step, so that the pyroelectric charges 10 reliably remain in the generation position thereof. Thus, the optical absorption can be reduced more stably and effectively than an optical element without steps.

In the present embodiment, wet etching is performed using a fluoronitric acid solution to form steps on the substrate, but chemical mechanical polishing may be performed to form the same steps. In particular, an acid or alkali chemical mechanical polishing solution having a large difference in etching rate in the z-axis direction can easily and effectively form steps.

In the first and second embodiments, the z-cut MgO-doped LiNbO₃ substrate is used as a ferroelectric substrate, but the ferroelectric substrate is not limited to the z-cut MgO-doped LiNbO₃ substrate. The ferroelectric substrate may be similar substrates having a stoichiometric composition including MgO-doped LiTaO₃ substrates, Nd-doped LiNbO₃ substrates, KTP substrates, KNbO₃ substrates, Nd:MgO-doped LiNbO₃ substrates or Nd:MgO-doped LiTaO₃ substrates, and Mg-doped LiTa (1−x) NbxO₃ (0≦x≦1).

The present invention is preferable for the fabrication of an optical element having a highly transparent polarization-reversed structure without crystal strains, since the present invention can stably produce a pyroelectric effect in annealing. Further, since the altered layers, impurities, or electrodes on the substrate surface are completely removed, the insulation of the substrate can be secured, thereby achieving an optical element with high output and stability.

The method for manufacturing an optical element according to the present invention can be used as a method for manufacturing a wavelength conversion element and the like with high efficiency and stability having a periodic polarization-reversed structure in, for example, a Mg-doped crystal. Moreover, the method for manufacturing an optical element according to the present invention makes it possible to provide a highly transparent optical element without crystal strains by stably forming and retaining a polarization-reversed region. The method can also provide a highly reliable optical element having polarization-reversed regions with stable optical output at the time of high output.

In the first and second embodiments, the optical element having a polarization-reversed structure is a wavelength conversion element. However, an optical element having a polarization-reversed structure formed in prismatic or grating shape may be applied to fabricate a deflector, in addition to the wavelength conversion element. The deflector may be applied to, for example, the phase shift, optical modulators, lenses, and so on. Moreover, a voltage is applied to a polarization-reversed region, so that a change in refractive index can be caused by an electro-optical effect. Thus, an optical element can be achieved using the change in refractive index. For example, since the change in refractive index can be controlled by an electric field, the optical element having the change in refractive index may be applied to switches, deflectors, modulators, phase shifters, beam forming, and so on. The method for manufacturing an optical element according to the present invention enables the formation of a polarization-reversed structure with stability and high transparency, thereby enhancing the performance of optical elements.

### INDUSTRIAL APPLICABILITY

The method for manufacturing an optical element according to the present invention is useful in fields in which an optical element having a polarization-reversed structure is required. In particular, the method for manufacturing an optical element according to the present invention makes it possible to stably form and retain polarization-reversed regions, and provide an optical element having the polarization-reversed regions with high reliability and stable optical output at the time of high output. Thus, the optical element is useful as an optical element having polarization-reversed regions which is applied to wavelength conversion elements, deflector elements, optical switches, phase modulators, and so on constituting coherent sources used in the fields of processing, optical information processing, and optical measurement control.

1. A method for manufacturing an optical element comprising:
an electrode forming step of forming metal films on a plus z face and a minus z face of a ferroelectric substrate to fabricate electrodes;
a periodic electrode forming step of forming the metal film formed on the plus z face into a periodic electrode;
a polarization reversal forming step of applying a voltage between the periodic electrode and the electrode on the minus z face to form polarization-reversed regions in the ferroelectric substrate;
a surface treating step of removing the electrode, the periodic electrode, and surface layers on the plus z face and the minus z face of the ferroelectric substrate; and
an annealing step of applying predetermined heat to the ferroelectric substrate having the surface layers removed therefrom.

2. The method for manufacturing an optical element according to claim 1, wherein the ferroelectric substrate is Mg-doped LiTa (1−x) NbxO₃ (0≦X≦1).

3. The method for manufacturing an optical element according to claim 2, wherein a crystal of the ferroelectric substrate has a stoichiometric composition.

4. The method for manufacturing an optical element according to claim 1, wherein a polarization reversal width of the polarization-reversed region is 2 μm or larger.

5. The method for manufacturing an optical element according to claim 1, wherein a depth of removal in the surface layer in the surface treating step is larger than 10 nm from a surface of the ferroelectric substrate.

6. The method for manufacturing an optical element according to claim 1, wherein the surface layers are removed by dry etching, wet etching, or polishing in the surface treating step.

7. The method for manufacturing an optical element according to claim 1, steps are formed between the adjacent polarization-reversed regions on the plus z face and the minus z face of the ferroelectric substrate.

8. The method for manufacturing an optical element according to claim 7, wherein wet etching is performed using an etching solution with anisotropy of an etching rate in a z-axis direction of the ferroelectric substrate to form the steps.

9. The method for manufacturing an optical element according to claim 8, wherein the etching solution is a fluoronitric acid solution.

10. The method for manufacturing an optical element according to claim 7, wherein polishing is performed using a polishing agent with anisotropy of a polishing rate in a z-axis direction of the ferroelectric substrate to form the steps.

11. The method for manufacturing an optical element according to claim 1, wherein silicon oxide films having predetermined resistivity are formed on the plus z face and the minus z face of the ferroelectric substrate before the annealing step.

12. The method for manufacturing an optical element according to claim 11, wherein the predetermined resistivity is 10⁵ Ω/□ or higher.

13. The method for manufacturing an optical element according to claim 1, wherein the annealing step is performed with the ferroelectric substrate held on an insulator.
